(19) United States
(12) Patent Application Publication
(10) Pub. No.: US 2007/0114221 A1
(43) Pub. Date: May 24, 2007

(54) Plate-shaped heater and steam cooking apparatus including the same

(75) Inventors: Jong Chull Shon, Suwon-si (KR); Sang Hoon Paik, Seongnam-si (KR); Soon Ki Kweon, Gwacheon-si (KR); Sung Ho Lee, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/542,438

(22) Filed: Oct. 4, 2006

(30) Foreign Application Priority Data
Nov. 24, 2005 (KR) 2005-113170
Nov. 24, 2005 (KR) 2005-113171

(51) Int. Cl. A21B 1/22; F27D 11/00

(52) U.S. Cl. 219/401

(57) ABSTRACT

A plate-shaped heater having a PTC temperature sensor to sense a temperature of the plate-shaped heater, and a steam cooking apparatus including the same. The plate-shaped heater includes an insulating substrate, a heating element formed of a resistor pattern-printed on the insulating substrate to generate heat, and a PTC temperature sensor to sense a heating temperature of the heating element. The PTC temperature sensor is pattern-printed on the insulating substrate, and therefore, has the effect of eliminating the risk of unintentional separation thereof, and achieving a simplified manufacturing process and reduced manufacturing costs. The PTC temperature sensor is disposed on the insulating substrate in an axis of direction having a wide distance between neighboring temperature contour lines, to achieve accurate temperature sensing capability thereof.

### CROSS-REFERENCE TO RELATED APPLICATION

This application claims the benefit of Korean Patent Applications Nos. 2005-0113170 and 2005-0113171, filed on Nov. 24, 2005 in the Korean Intellectual Property Office, the disclosure of which is incorporated herein by reference.

### BACKGROUND OF THE INVENTION

1. Field of the Invention

The present invention relates to a plate-shaped heater and a steam cooking apparatus including the same, and, more particularly, to a plate-shaped heater having a positive temperature coefficient (PTC) temperature sensor to sense a temperature of the plate-shaped heater and a steam cooking apparatus including the same.

2. Description of the Related Art

Generally, examples of conventional food cooking methods include a method for cooking food contained in a gas oven or electric oven by directly applying heat to the food, a method for heating a steam container containing food to cook the food indirectly, and a method for cooking food using high-frequency waves from a microwave oven.

When cooking food by directly heating the food using a gas oven or electric oven, there is a problem of food oxidization because the food comes into contact with oxygen contained in the air and this results in deterioration in the taste of food. When cooking food using a steam container, the food contains an excessive amount of moisture and suffers from a reduction in peculiar flavor thereof. Also, when cooking food using a microwave oven, there is a problem in that high-frequency waves may fail to evenly irradiate the food, resulting in localized over or under cooking of the food.

To solve the above described problems of conventional cooking methods, a cooking apparatus for cooking food by supplying superheated steam to the food was developed, and many technologies have been published in relation with the cooking apparatus using superheated steam. It could be found that, when cooking food using the cooking apparatus using superheated steam, high-temperature superheated steam is directly delivered to an overall surface of the food and this has the effects of preventing over or under cooking of the food and keeping an appropriate amount of moisture in the overall food suitable to guarantee good taste of the food. An example of a cooking apparatus using superheated steam is disclosed in Japanese Patent Laid-Open Publication No. 2005-0061816.

A steam cooking apparatus disclosed in the above mentioned Japanese Patent Laid-Open Publication No. 2005-0061816 includes a water tank, a steam generating device, a steam heater, and a blowing device, and is adapted to supply superheated steam into a cooking compartment, so as to cook food by heat contained in the superheated steam. The disclosed steam generating device includes an annular sheath heater, which is configured to surround an outer surface of a pot, so as to generate steam by heating water stored in the pot. No published steam cooking apparatuses including that of the above mentioned Japanese Patent Laid-Open Publication have a steam generating device using a plate-shaped heater.

Korean Patent Laid-Open Publication No. 10-2005-0028970 discloses a printed circuit board (PCB) type heater and a method for manufacturing the same. The disclosed PCB type heater includes a heating resistor, power supply terminals, a sensor and sensor mount, and sensor connecting terminals, and is pattern-printed on an insulating substrate.

However, in the above described PCB type heater, since the sensor mount is secured to the insulating substrate and the sensor is mounted to the sensor mount, there is a problem in that the sensor may be separated from the sensor mount, or the sensor mount may be separated from the insulating substrate. In addition, the PCB type heater has a problem of excessive manufacturing costs caused by a great number of constituent elements and complicated manufacturing process thereof.

Further, when being operated to generate heat, the PCB type heater may experience an interior temperature gradient depending on the shape thereof. The above mentioned Korean Patent Laid-Open Publication has no explanation about the attachment position of a sensor for sensing an accurate temperature of the heater without the effect of the temperature gradient.

### SUMMARY OF THE INVENTION

The present invention has been made in order to solve the above problems. It is an aspect of the invention to provide a plate-shaped heater which is configured to prevent separation of a PTC temperature sensor included therein and can achieve a reduction in manufacturing costs, and a steam cooking apparatus including the same.

It is a further aspect of the invention to provide a plate-shaped heater having a PTC temperature sensor installed at an optimal position for measuring an accurate heating temperature of the plate-shaped heater, and a steam cooking apparatus including the same.

Consistent with one aspect, an exemplary embodiment of the present invention provides a plate-shaped heater including: an insulating substrate; at least one heating element formed of a resistor pattern-printed on the insulating substrate to generate heat; and at least one PTC temperature sensor to sense a heating temperature of the heating element, where the PTC temperature sensor is pattern-printed on the insulating substrate.

The PTC temperature sensor may be linearly disposed on the insulating substrate in an axis of direction having a wide distance between neighboring temperature contour lines, to achieve accurate temperature sensing.

The PTC temperature sensor may be formed on the center of the insulating substrate.

The at least one heating element may include a plurality of heating elements, and the at least one PTC temperature sensor may include a plurality of PTC temperature sensors to be formed at the center of the heating elements, respectively.

The insulating substrate may be provided, at a side thereof, with power supply terminals to supply power to the plurality of heating elements, and the power supply terminals may include a plurality of power input terminals connected to the respective heating elements, and a single common power output terminal.

The PTC temperature sensor may include: a PTC resistor pattern-printed on the insulating substrate; and connection terminals provided at both ends of the PTC resistor.

Consistent with another aspect, an exemplary embodiment of the present invention provides a plate-shaped heater including: an insulating substrate; at least one heating element formed of a heating resistor pattern-printed on the insulating substrate to generate heat; and at least one PTC temperature sensor to sense a heating temperature of the heating element, where the PTC temperature sensor is linearly disposed on the insulating substrate in an axis of direction having a wide distance between neighboring temperature contour lines, to achieve accurate temperature sensing.

Consistent with yet another aspect, an exemplary embodiment of the present invention provides a steam cooking apparatus including a cooking compartment and a steam generating unit disposed at the outside of the cooking compartment and adapted to generate steam to be supplied into the cooking compartment, where the steam generating unit includes a plate-shaped heater, and wherein the plate-shaped heater includes: an insulating substrate; at least one heating element formed of a resistor pattern-printed on the insulating substrate to generate heat; and at least one PTC temperature sensor pattern-printed on the insulating substrate to sense a heating temperature of the heating element.

The PTC temperature sensor may be linearly disposed on the insulating substrate in an axis of direction having a wide distance between neighboring temperature contour lines, to achieve accurate temperature sensing.

The PTC temperature sensor may be provided at the center of the heating element.

The PTC temperature sensor may include: a PTC resistor pattern-printed on the insulating substrate; and connection terminals provided at both ends of the PTC resistor.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a perspective view showing the configuration of a steam cooking apparatus consistent with an exemplary embodiment of the present invention;

FIG. 2 is a front view showing the outer appearance of the steam cooking apparatus consistent with the exemplary embodiment of the present invention;

FIG. 3 is a sectional view of the steam cooking apparatus consistent with the exemplary embodiment of the present invention;

FIG. 4 is an exploded perspective view showing the configuration of a steam generating unit and a plate-shaped heater included in the steam generating unit;

FIG. 5 is a plan view showing a plate-shaped heater consistent with another exemplary embodiment of the present invention; and

FIG. 6 is a plan view showing a plate-shaped heater consistent with yet another exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to like elements throughout. The embodiments are described below to explain the present invention by referring to the figures.

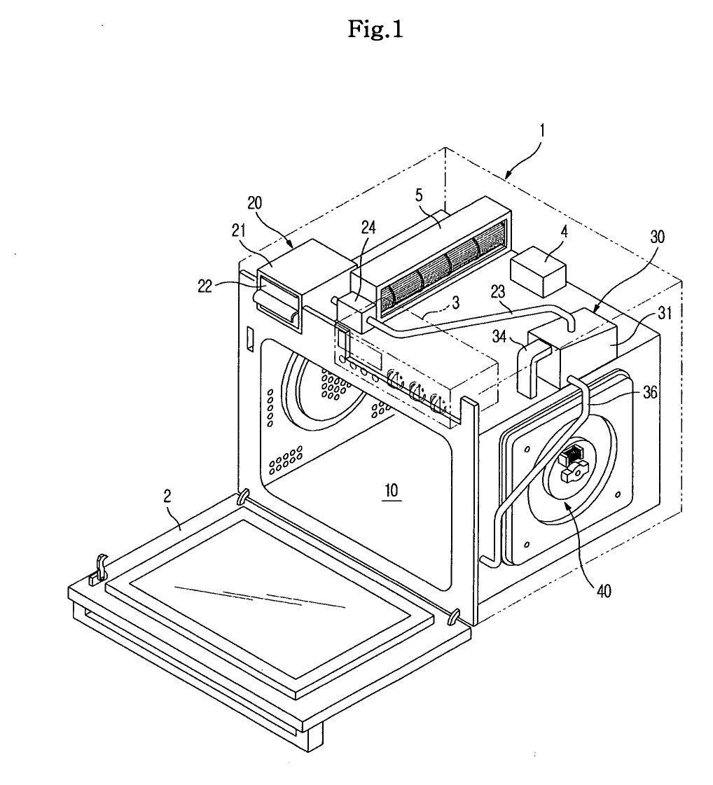

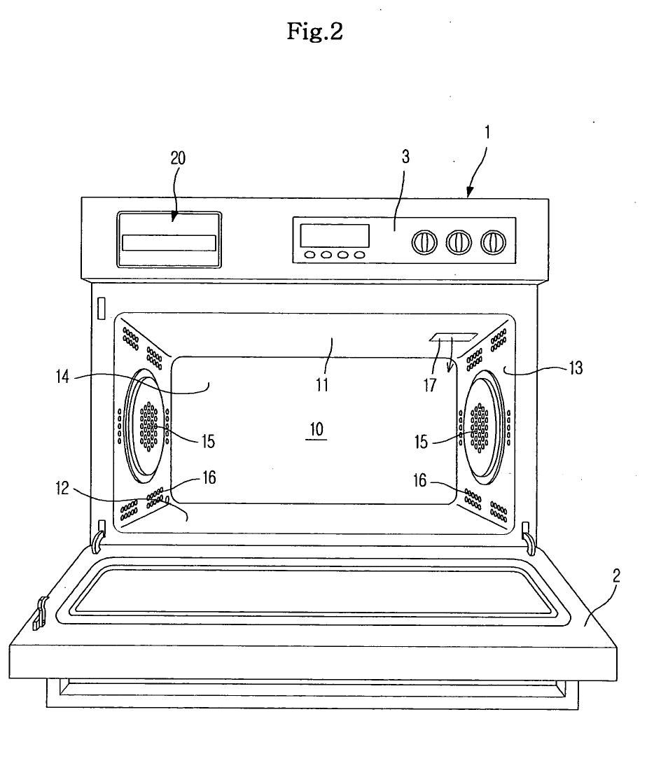

FIG. 1 is a perspective view showing the configuration of a steam cooking apparatus consistent with an exemplary embodiment of the present invention. FIG. 2 is a front view showing the outer appearance of the steam cooking apparatus consistent with the exemplary embodiment of the present invention.

As shown in FIGS. 1 and 2, the steam cooking apparatus consistent with the exemplary embodiment of the present invention includes a housing 1 forming the outer appearance of the apparatus, a cooking compartment 10 defined in the housing 1 to have a predetermined space with the housing 1, a door 2 to open and close an open front surface of the cooking compartment 10, and a control panel 3 installed on the cooking compartment 10. The steam cooking apparatus of the present invention further includes a water supply unit 20, a steam generating unit 30, and a pair of superheated steam supply units 40, which are disposed in the space between the housing 1 and the cooking compartment 10 to supply steam into the cooking compartment 10.

The cooking compartment 10 is constructed by a top plate 11, bottom plate 12, opposite lateral plates 13, and a rear plate 14, and has an inner space having a predetermined volume required to cook food. An insulating member (not shown) encloses the cooking compartment 10 to prevent leakage of heat from the cooking compartment 10. Also, a magnetron 4 for generating microwaves and a cross-flow fan 5 for cooling the magnetron 4, steam generating unit 30, other electric elements, etc. are provided at an outer surface of the top plate 11 of the cooking compartment 10.

A plurality of small-diameter inlet holes 15 are arranged at the center of the respective lateral plates 13, and a plurality of small-diameter outlet holes 16 are arranged around the inlet holes 15, more particularly, along the periphery of the respective lateral plates 13. The plurality of outlet holes 16 may be symmetrically arranged at front and rear sides and upper and lower sides of the plurality of inlet holes 15. With the configuration of the lateral plates 13 of the cooking compartment 10, steam inside the cooking compartment 10 is introduced into the superheated steam supply units 40 through the inlet holes 15, and again returned into the cooking compartment 10 through the outlet holes 16 after being superheated to a high temperature.

The water supply unit 20 is mounted on an outer surface of the top plate 11 at a front location of the top plate 11. The water supply unit 20 includes a water supply case 21, a water supply container 22 slidable in the water supply case 21 to be inserted into or taken out of the water supply case 21, a water supply pipe 23 to connect the water supply unit 20 to the steam generating unit 30, and a pump 24 provided on the water supply pipe 23 to supply water into the steam generating unit 30.

In the water supply unit 20 having the above described configuration, if water is filled in the water supply container 22, the water is pumped by the pump 24, to be supplied into the steam generating unit 30 through the water supply pipe 23.

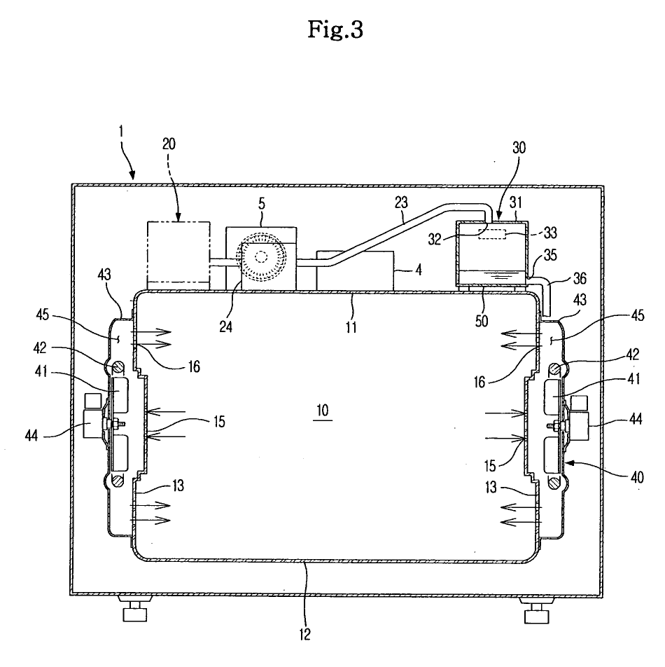

FIG. 3 is a sectional view of the steam cooking apparatus consistent with the exemplary embodiment of the present invention.

The steam generating unit 30, as shown in FIG. 3, has an approximately box shape, and is mounted on the outer surface of the top plate 11 at a lateral portion of the top plate 11. The steam generating unit 30 includes a steam generating container 31 that is connected to the water supply pipe 23 and adapted to receive the water introduced thereinto through the water supply pipe 23, and a plate-shaped heater 50 that forms a bottom wall of the steam generating container 31 and is adapted to heat the water received in the steam generating container 31, so as to generate steam.

The steam generating container 31 is perforated in a top wall thereof with a water supply hole 32 for the connection of the water supply pipe 23, and in an upper portion of a front wall thereof with a steam outlet opening 33 for supplying steam generated in the steam generating container 31 to the cooking compartment 10. A steam supply duct 34 is connected to the steam outlet opening 33 to communicate with a steam inlet opening 17 of the cooking compartment 10. With this configuration, if steam is generated in the steam generating container 31, the steam is supplied into the cooking compartment 10 through the steam supply duct 34. The steam generating container 31 is further perforated, in a lower portion of a lateral wall thereof, with a drain hole 35 so that a drain pipe 36 is connected to the drain hole 35, to drain water remaining in the steam generating container 31 after a cooking operation of the steam cooking apparatus is completed.

The superheated steam supply units 40 are provided at outer surfaces of both the lateral plates 13 of the cooking compartment 10, respectively. Each of the superheated steam supply units 40 includes a circulating fan 41 to forcibly circulate the interior air of the cooking compartment 10 into the superheated steam supply unit 40 through the inlet holes 15 and again into the cooking compartment 10 through the outlet holes 16, a superheating heater 42 to heat the circulating air, so as to change steam included in the air into superheated steam, a case 43 coupled to the associated lateral plate 13 to encase the circulating fan 41 and superheating heater 42, and a motor 44 mounted to an outer surface of the case 43 and used to operate the circulating fan 41. With this configuration, a superheated steam duct 45 is defined between an outer surface of the lateral plate 13 and the case 43, and the circulating fan 41 and superheating heater 42 are located in the superheated steam duct 45. The interior air of the cooking compartment 10 is introduced into the superheated steam duct 45 through the inlet holes 15, and again returned into the cooking compartment 10 through the outlet holes 16 after being changed to the superheated steam by the superheating heater 42.

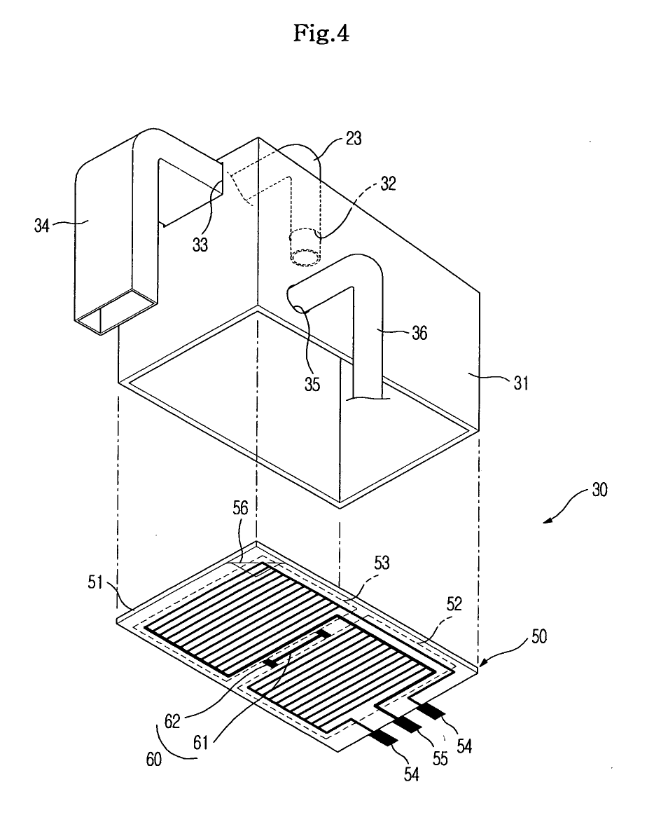

FIG. 4 is an exploded perspective view showing the configuration of the steam generating unit and the plate-shaped heater included in the steam generating unit.

As shown in FIG. 4, the plate-shaped heater 50, which forms the bottom wall of the steam generating unit 30, includes an insulating substrate 51, one or more heating elements 52 and 53 formed of heating resistors pattern-printed on a surface of the insulating substrate 51, the heating elements 52 and 53 being adapted to generate a preset amount of heat if power is applied thereto, and a PTC temperature sensor 60 to sense a heating temperature of the heating elements 52 and 53.

The plate-shaped heater 50 is a heater designed by pattern-printing a heating resistor on an insulating substrate by a PCB technique to allow the substrate to emit heat by itself. As compared to general heaters such as a sheath heater, etc., the plate-shaped heater has various advantages of rapid heating, generation of high temperature heat, simplified temperature regulating operation, high responsivity, etc. For these many advantages, the plate-shaped heater is able to be widely applicable to a variety of heating devices as well as the above described steam cooking apparatus consistent with the exemplary embodiment of the present invention. In particular, when being used in the steam cooking apparatus of the present invention, the plate-shaped heater 50 can realize instantaneous steam generation, and can generate steam even if only a small amount of water exists in the steam generating container 31.

The plate-shaped heater 50, which forms the bottom wall of the steam generating container 31, is provided with heating resistors having a ladder pattern suitable to obtain a maximum electric heating area.

The insulating substrate 51 included in the plate-shaped heater 50 takes the form of an approximately rectangular thin plate. Power supply terminals 54 and 55 for supplying power to the heating elements 52 and 53 of the plate-shaped heater 50 are provided on a surface of the insulating substrate 51.

Although the power supply terminals 54 and 55 may include power input and output terminals exclusive to each heating element 52 or 53, in the present invention, two power input terminals 54 for the respective heating elements 52 and 53 and a single common power output terminal 55 are used. Thereby, the number of power output terminals can be reduced, and the pattern of the heating resistors can be simplified.

The heating elements 52 and 53 are formed of the pattern-printed heating resistors on the surface of the insulating substrate 51. The heating resistors are pattern-printed on the insulating plate 51 based on the fact that the resistance of the heating resistors is proportional to the intrinsic resistance value and length of the resistors but is inversely proportional to the sectional area of the heating resistors. Accordingly, even when constant power is supplied, the heating elements 52 and 53 can achieve a variety of desired outputs by changing the resistance of the heating resistors.

Depending on the pattern-printed shape of the resistors, two or more heating elements 52 and 53 may be provided, and these heating elements 52 and 53 are operable independently. For the convenience of explanation, in the exemplary embodiment of the present invention, it is assumed that the heating elements 52 and 53 include a first heating element 52 and a second heating element 53, which have different outputs from each other. It will be understood that the outputs of the heating elements 52 and 53 may be determined differently in consideration of the size of the cooking compartment, a desired supply amount of steam, and the like.

The heating elements 52 and 53 serve to heat the water received in the steam generating container 31 so as to generate steam. As will be expected, if no water exists in the steam generating container 31, the heating elements 52 and 53 must experience a rapid increase in temperature, and this may cause a failure of the plate-shaped heater 50. To solve this problem, the plate-shaped heater 50 includes the PTC temperature sensor 60 capable of sensing the temperature of the heating elements 52 and 53.

Generally, a positive temperature coefficient (PTC) resistor has characteristics of always keeping a constant temperature by changing a resistance thereof in response to a variation of surrounding temperature. The PTC temperature sensor is adapted to sense a temperature by measuring a variation of resistance based on the characteristics of the PTC resistor.

The PTC temperature sensor 60 included in the plate-shaped heater 50 of the present invention is obtained by pattern-printing a PTC resistor 61 on the insulating substrate 51. The PTC temperature sensor 60 is adapted to sense a heating temperature of the heating elements 52 and 53 by measuring a resistance value of the PTC resistor 61. In consideration of the fact that the center portion of the plate-shaped heater 50 has a temperature greater than that of the remaining portion of the heater 50, the PTC temperature sensor 60 is preferably formed at the center portion of the insulating substrate 51, to sense overheating of the plate-shaped heater 50.

As a result of directly forming the PTC temperature sensor 60 on the insulating substrate 51 of the plate-shaped heater 50 by a pattern-printing technique, there is no risk of separation of the PTC temperature sensor 60 from the plate-shaped heater 50.

The PTC resistor 61 is provided, at both ends thereof, with connection terminals 62 to transmit a resistance value measured by the PTC resistor 61 to an external station.

Now, the manufacture of the plate-shaped heater 50 will be explained.

The heating resistors are patterned to have a ladder shape, so as to form the heating elements 52 and 53 on the insulating substrate 51. Also, the PTC resistor 61 is patterned to form the PTC temperature sensor 60 at an intermediate position between the heating elements 52 and 53. After patterning of the resistors, the insulating substrate 61, formed with the patterns, is etched corrosively, to complete the pattern-printing of the heating elements 52 and 53 and PTC temperature sensor 60. Subsequently, to insulate the pattern-printed heating elements 52 and 53 and PTC temperature sensor 60, an insulating protective film 56 is formed on the printed surface of the insulating substrate 51 except for both the ends of the PTC resistor 61 where the connection terminals 62 will be mounted. Finally, if the connection terminals 62 are deposited and secured to the ends of the PTC resistor 61, the manufacture of the plate-shaped heater 50 is completed.

Hereinafter, the operation of the steam cooking apparatus having the above described configuration consistent with the present invention will be explained with reference to the drawings.

If a user puts food into the cooking compartment 10 and inputs a cooking command by operating the control panel 3, the pump 24 is operated, to supply water from the water supply unit 20 into the steam generating container 31 of the steam generating unit 30.

To generate steam depending on different cooking commands, it is preset whether the plurality of heating elements 52 and 53 are simultaneously operated or independently operated. For example, if a cooking command is input to cook food rapidly with a great amount of steam, the first and second heating elements 52 and 53 are operated simultaneously, to heat the water received in the steam generating container, so as to generate an increased amount of steam more rapidly. If a cooking command requiring a low level of quickness is input, the first heating element 52 or second heating element 53 is operated, so as to generate steam.

Accordingly, if the water is supplied into the steam generating container 31 based on the input cooking command, the first and second heating element 52 and 53 of the plate-shaped heater 50 are simultaneously operated or independently operated to exhibit the preset output, so as to generate a predetermined amount of steam in response to the input cooking command.

In this case, if no water is supplied into the steam generating container 31 or the previously supplied water is wholly changed into steam and thus, no water exists in the steam generating container 31, the steam generating container 31 may suffer from a rapid increase in temperature. The PTC temperature sensor 60 of the plate-shaped heater 50 senses the increase in the temperature of the steam generating container 31, to supply water into the steam generating container 31 or intercept power if the temperature of the heating elements 52 and 53 increases beyond a predetermined temperature.

The steam, which is generated in the steam generating unit 30 by the heating operation of the plate-shaped heater 50, is introduced into the cooking compartment 10 through the steam supply duct 34, and in turn, is delivered into the superheated steam duct 45 through the inlet holes 15 in accordance with operation of the circulating fans 41 of the superheated steam supply units 40. Thereby, the steam is changed into superheated steam having a higher temperature by operation of the circulating fans 41 and superheating heaters 42 disposed in the superheated steam ducts 45. Then, the superheated steam is supplied into the cooking compartment 10 through the plurality of outlet holes 16 perforated in the lateral plates 13 of the cooking compartment 10.

With the above described procedure, a forcible circulating operation for continuously changing the interior air of the cooking compartment 10 into the superheated steam by operation of the circulating fans 41 and superheating heaters 42 and returning the resulting superheated steam into the cooking compartment 10 can be achieved.

Thereafter, if food is completely cooked, one-cycle of cooking ends, and the water remaining in the steam generating container 31 is discharged to the bottom plate 12 of the cooking compartment 10 through the drain pipe 36.

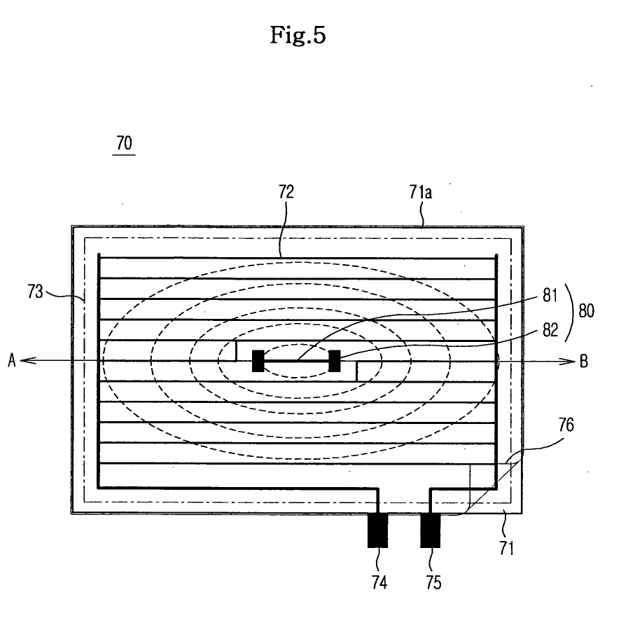

FIG. 5 is a plan view showing a plate-shaped heater consistent with another exemplary embodiment of the present invention.

As shown in FIG. 5, the plate-shaped heater 70 consistent with another exemplary embodiment of the present invention includes an insulating substrate 71, a heating element 73 formed of a heating resistor 72 pattern-printed on a surface of the insulating substrate 71, the heating element 73 being adapted to generate a preset amount of heat if power is supplied thereto, and a PTC temperature sensor 80 to sense a heating temperature of the heating element 73. Similar to the above described embodiment, the plate-shaped heater 70 forms the bottom wall of the steam generating container.

The insulating substrate 71 included in the plate-shaped heater 70 takes the form of an approximately rectangular thin plate. Power supply terminals 74 and 75 for supplying power to the heating element 73 of the plate-shaped heater 70 are provided on a surface of the insulating substrate 71.

The heating element 73 is formed of a heating resistor 72 pattern-printed on the surface of the insulating substrate 71. As will be expected, if no water exists in the steam generating container 31, the heating element 73 must experience a rapid increase in temperature, and this may cause a failure of the plate-shaped heater 70. To solve this problem, the plate-shaped heater 70 includes a PTC temperature sensor 80 capable of sensing the temperature of the heating element 73.

The insulating substrate 71 comes into contact, at a rim portion 71a thereof, with a lower end of the steam generating container 31. Therefore, if the heating element 73 generates heat upon receiving power applied to the plate-shaped heater 70, the heat of the heating element 73 is transmitted to the steam generating container 31 through the rim portion 71 a of the insulating substrate 71, or comes into contact with the air to cause heat transfer. With the heat transfer, the insulating substrate 71 exhibits a temperature distribution decreasing from the center of the insulating substrate 71 to the rim portion 71 a of the substrate 71. The approximate temperature distribution of the plate-shaped heater 71 can be represented by elliptical temperature contour lines as shown by dotted lines in FIG. 5.

The PTC temperature sensor 80 is adapted to sense a temperature by measuring a resistance value depending on an installation position of a PTC resistor 81. If the PTC resistor 81 is installed at a steep temperature gradient region in the insulating substrate 71, the PTC temperature sensor 80 has a difficulty to measure an accurate resistance value, and thus, may fail to calculate an accurate temperature.

To provide the PTC temperature sensor 80 with an accurate temperature sensing capability, the PTC resistor 81 has to be installed at a gentle temperature gradient region of the insulating substrate 71. Therefore, the PTC resistor 81 of the PTC temperature sensor 80 is linearly pattern-printed on an axis of A-B direction having a wide distance between neighboring temperature contour lines. With the arrangement of the PTC resistor 81, a temperature difference between both ends of the PTC resistor 81 is relatively reduced. Therefore, the accurate measurement of a resistance value is possible, and this enables the plate-shaped heater 70 to accurately calculate a heating temperature.

The center portion of the plate-shaped heater 70 has a temperature greater than that of the remaining portion of the heater 70. Accordingly, to sense overheating of the plate-shaped heater 70, the PTC temperature sensor 80 is preferably formed at the center portion of the insulating substrate 71, and the PTC resistor 81 is linearly pattern-printed in a direction having a wide distance between neighboring temperature contour lines. Further, to insulate the heating element 73 and PTC temperature sensor 80, an insulating protective film 76 is formed on the printed surface of the insulating substrate 71 except for both the ends of the PTC resistor 81 where the connection terminals 82 are mounted.

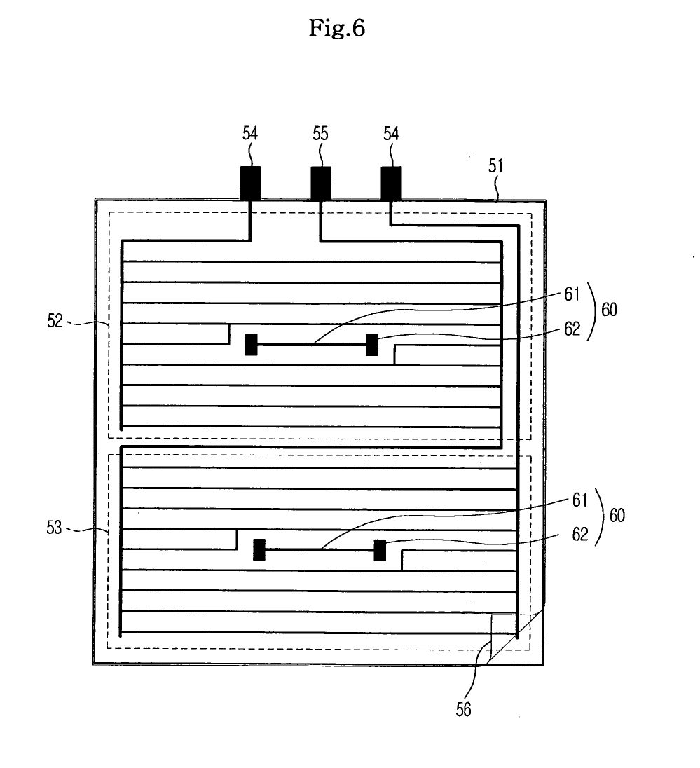

Next, a plate-shaped heater consistent with yet another embodiment of the present invention will be explained. FIG. 6 is a plan view showing the plate-shaped heater consistent with yet another exemplary embodiment of the present invention. The plate-shaped heater of the present embodiment is similar to that of the above described embodiment except for the fact that the PTC sensor 60 is provided at each of the heating elements 52 and 53. Accordingly, the same constituent elements as those of the above described embodiment will be designated as the same reference numerals, and detailed description thereof will be omitted.

In the present embodiment, the heating elements 52 and 53 of the plate-shaped heater 50 are operated independently of each other. Therefore, when any one of the heating elements 52 and 53 is operated, it is preferable that the heating elements 52 and 53 be provided with the PTC temperature sensors 60, respectively, to accurately measure the temperature of the plate-shaped heater 50. Accordingly, the plate-shaped heater 50 consistent with yet another embodiment of the present invention includes two PTC temperature sensors 60 pattern-printed on the center of the respective heating elements 52 and 53.

As apparent from the above description, the present invention provides a plate-shaped heater in which a PTC temperature sensor is directly formed on an insulating substrate of the plate-shaped heater by a pattern-printing technique, thereby eliminating the risk of separation of the PTC temperature sensor, and a steam cooking apparatus including the same.

As a result of integrally forming the PTC temperature sensor and heating resistor with the insulating substrate, according to the present invention, the overall manufacturing process of the plate-shaped heater can be simplified, and the manufacturing costs thereof can be reduced.

Furthermore, according to the present invention, the PTC temperature sensor is arranged on the insulating substrate in a direction having a wide distance between neighboring temperature contour lines. This has the effect of guaranteeing a high accuracy temperature sensing capability of the PTC temperature sensor.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plate-shaped heater comprising:
an insulating substrate;
at least one heating element formed of a resistor pattern-printed on the insulating substrate to generate heat; and
at least one positive temperature coefficient (PTC) temperature sensor to sense a heating temperature of the heating element,
wherein the PTC temperature sensor is pattern-printed on the insulating substrate.

2. The heater according to claim 1, wherein the PTC temperature sensor is linearly disposed on the insulating substrate in an axis of direction having a wide distance between neighboring temperature contour lines, to achieve accurate temperature sensing.

3. The heater according to claim 2, wherein the PTC temperature sensor is formed on the center of the insulating substrate.

4. The heater according to claim 2, wherein:
the at least one heating element comprises a plurality of heating elements, and the at least one PTC temperature sensor comprises a plurality of PTC temperature sensors to be formed at the center of the heating elements, respectively.

5. The heater according to claim 4, wherein:
the insulating substrate is provided, at a side thereof, with power supply terminals to supply power to the plurality of heating elements; and
the power supply terminals comprise a plurality of power input terminals connected to the respective heating elements, and a single common power output terminal.

6. The heater according to claim 1, wherein the PTC temperature sensor comprises:
a PTC resistor pattern-printed on the insulating substrate; and
connection terminals provided at both ends of the PTC resistor.

7. A plate-shaped heater comprising:
an insulating substrate;
at least one heating element formed of a heating resistor pattern-printed on the insulating substrate to generate heat; and
at least one positive temperature coefficient (PTC) temperature sensor to sense a heating temperature of the heating element,
wherein the PTC temperature sensor is linearly disposed on the insulating substrate in an axis of direction having a wide distance between neighboring temperature contour lines, to achieve accurate temperature sensing.

8. The heater according to claim 7, wherein the resistor of the at least one heating element is formed in a ladder pattern.

9. The heater according to claim 7, further comprising an insulating protective film formed on the at least one heating element.

10. A steam cooking apparatus comprising:
a cooking compartment; and
a steam generating unit disposed at the outside of the cooking compartment and adapted to generate steam to be supplied into the cooking compartment,
wherein
the steam generating unit comprises a plate-shaped heater, and
the plate-shaped heater comprises:
an insulating substrate;
at least one heating element formed of a resistor pattern-printed on the insulating substrate to generate heat; and
at least one positive temperature coefficient (PTC) temperature sensor pattern-printed on the insulating substrate to sense a heating temperature of the heating element.

11. The apparatus according to claim 10, wherein the PTC temperature sensor is linearly disposed on the insulating substrate in an axis of direction having a wide distance between neighboring temperature contour lines, to achieve accurate temperature sensing.

12. The apparatus according to claim 10, wherein the PTC temperature sensor is provided at the center of the heating element.

13. The apparatus according to claim 10, wherein the PTC temperature sensor comprises:
a PTC resistor pattern-printed on the insulating substrate; and
connection terminals provided at both ends of the PTC resistor.

14. The apparatus according to claim 10, wherein the resistor of the at least one heating element is formed in a ladder pattern.

15. The apparatus according to claim 10, wherein the insulating plate is formed as a substantially rectangular plate.

16. The apparatus according to claim 10, wherein the plate shaped heater further comprises an insulating protective film formed on the at least one heating element.
